(19) United States
(12) Patent Application Publication
(10) Pub. No.: US 2025/0378499 A1
(43) Pub. Date: Dec. 11, 2025

(54) System and Method for Quantifying Investor Behavioral Risk Impact on Investment Outcomes

(71) Applicant: Jian Helen Yang, Lexington, MA (US)

(72) Inventor: Jian Helen Yang, Lexington, MA (US)

(73) Assignee: ANDES WEALTH TECHNOLOGIES INC., Lexington, MA (US)

(21) Appl. No.: 19/232,506

(22) Filed: Jun. 9, 2025

Related U.S. Application Data
(60) Provisional application No. 63/658,062, filed on Jun. 10, 2024.

(51) Int. Cl. G06Q 40/06; G06F 16/904

(52) U.S. Cl. CPC G06Q 40/06; G06F 16/904

(57) ABSTRACT

A system and method for quantifying the impact of investor behavioral persona on investment outcomes. A Behavioral Risk Index (BRI) is calculated based on investor behavioral factors including investor type, behavioral biases, and financial literacy. The system simulates behavior-impacted investment returns by mapping exit and re-entry points of investor groups sharing a common behavior persona during historical market events. The simulated behavior-impacted investment outcomes is quantified by comparing to buy-and-hold strategy. Personalized visualizations, including the visualization of the BRI, behavioral factor breakdowns and performance comparisons, are displayed to assist financial professionals and investors in identifying behavioral risk exposure and demonstrating the value of behavioral coaching.

### CROSS-REFERENCE TO RELATED APPLICATIONS

This application claims priority to U.S. Provisional Patent Application No. 63/658,062, filed on Jun. 10, 2024, the entire contents of which are incorporated herein by reference. This invention is an extension of U.S. Pat. No. 11,610,266, issued to Jian Helen Yang, incorporated herein by reference.

### BACKGROUND OF THE INVENTION

This invention pertains to the field of computing behavioral finance and analytic investment management aided by computer systems, specifically to computer systems and methods for quantifying the impact of investor behavioral risk on investment outcomes.

In the domain of finance and investment, understanding investor behavior is critical, particularly during periods of market volatility. Behavioral finance research has established that psychological factors and cognitive biases significantly influence investment decisions. Ignoring these behavioral factors can result in suboptimal investment strategies and adverse financial outcomes.

A primary challenge in behavioral finance is quantifying the impact of behavioral risk on investment performance. One approach involves analyzing transaction data to infer behavioral patterns. However, obtaining comprehensive, long-term transaction data for individual investors is often impractical. Additionally, transactions may be driven by personal life events or liquidity needs, such as inheritance or major purchases, which complicates isolating behavioral influences. Even when transaction records are available, investors may struggle to accurately attribute decisions to emotional responses versus external necessities.

Research by Vanguard has quantified the value of financial advisors, termed “advisor's alpha,” at up to 300 basis points annually, with behavioral coaching contributing up to 200 basis points. Its analysis relies on aggregate fund inflow and outflow data, which effectively captures collective investor behavior but is less applicable to individual investors. For example, different investor types—passive, trend-following, or contrarian—exhibit distinct reactions to market conditions, necessitating a more individualized approach.

The present invention addresses these challenges by simulating investor behavior during various market cycles based on individual Behavioral Risk Index (BRI) profiles, as introduced in U.S. Pat. No. 11,610,266. By modeling market exit and re-entry points driven by behavioral factors, the system provides a method to simulate and quantify Behavioral Risk Index impact on investment outcomes, providing personalized insights for investors and advisors.

### SUMMARY OF THE INVENTION

This invention extends the framework of U.S. Pat. No. 11,610,266, which introduced the Behavioral Risk Index (BRI), a metric ranging from 0 to 10 that quantifies an investor's behavioral risk based on factors such as investor type, financial IQ, and behavioral biases, including loss aversion, overconfidence, and herding. The present invention provides a system and method for assessing the impact of BRI on investment performance by simulating investor behavior across market cycles.

The system employs a Behavioral Analytics Engine to calculate BRI and map investor actions—specifically market exit and re-entry points—to an emotional rollercoaster model, which correlates emotions such as anxiety, fear, optimism, and excitement to market phases. Using historical market data and empirical observations, the system simulates investment outcomes for investors with varying behavioral profiles, as represented by various BRI levels or Investor Persona (as defined in the Detailed Description) or combinations of various factors, comparing these to a buy-and-hold strategy. The results demonstrate how behavioral biases lead to suboptimal market timing, particularly for investors with higher BRI scores, resulting in reduced returns.

Key components include a BRI Calculation Module, an Empirical Data Mapping Module, a Performance Quantification Module, and a Simulation Module, which collectively analyze investor behavior and its financial consequences. The system supports applications for individual investors, financial advisors, and institutional investors, offering personalized insights, enhanced decision-making, and improved risk management.

### BRIEF DESCRIPTION OF DRAWINGS

FIG. 1A illustrates an Emotional Rollercoaster Model (as defined in the Detailed Description) that may be experienced by investors during market cycles or significant events, depicting a curved line representing market conditions or event progression. Emotions such as optimism, excitement, exuberance, anxiety, fear, panic, depression, hope, and relief are marked along the curve, corresponding to specific market phases or event stages, in accordance with this application.

FIG. 1B depicts an example set of functional components of the Behavioral Risk Management System, including a user interface module, application server, database, Behavioral Analytics Engine, and output module including Behavioral Risk Visualization Module and Behavioral Impact Visualization Module. The engine comprises a Behavioral Assessment Questionnaires and Tools module and a Behavioral Analytics Algorithms module, illustrating the flow of data from user input to behavioral risk analysis to the output visualization, in accordance with this application.

FIG. 1C presents an example high-level diagram of the Behavioral Risk Index (BRI) (as defined in the Detailed Description) calculation, aggregating inputs such as Investor Type, Behavioral Biases (e.g., loss aversion, overconfidence, herding), Describe Yourself, Financial IQ, and Risk Inconsistency into a single score using a weighted average algorithm, in accordance with this application.

FIG. 2 displays an example table summarizing the average market exit and re-entry points for investors grouped by BRI levels—low (0-3), medium (4-6), medium-high (7-8), and high (9-10)—across four market events (2000 Tech Bubble, 2008 Financial Crisis, COVID-19 market turmoil, 2022 Market Correction). The table correlates exit points with emotions (anxiety, fear, panic) and re-entry points with emotions (relief, optimism, excitement), in accordance with this application.

FIG. 3 illustrates an example simulated line graph showing the growth of a $1,000,000 investment in the S&P 500 from Jan. 1, 2000, to Apr. 30, 2025, for an investor classified as having high behavioral risk (BRI score 9-10, color-coded red). The upper blue line represents the Buy-and-Hold Performance (as defined in the Detailed Description below), reaching approximately $6,000,000, corresponding to an annualized Buy-and-Hold Return of 7.28%. The lower line, rendered in red to match the high BRI color code, represents the Behavior-Impacted Performance (as defined in the Detailed Description below) of the same investment strategy with simulated investor behavior involving market exits during periods of anxiety and re-entries during periods of excitement, yielding an approximate ending value of $3,200,000, corresponding to an annualized Behavior-Impacted Return of 4.74%.

FIG. 4 illustrates an example simulated line graph representing the growth of a $1,000,000 investment in the S&P 500 from Jan. 1, 2000, to Apr. 30, 2025, for an investor classified as having medium-high behavioral risk (Behavioral Risk Index score of 7-8, color-coded orange). The upper blue line reflects the Buy-and-Hold Performance, resulting in an approximate ending value of $6,000,000, corresponding to an annualized Buy-and-Hold Return of 7.28%. The lower line, rendered in orange to match the medium-high BRI color code, represents the Behavior-Impacted Performance of the same investment strategy with simulated investor behavior involving market exits during periods of fear and re-entries during periods of optimism, as defined for each of the four market events described herein. This behavioral pattern yields an approximate ending value of $3,700,000, corresponding to an annualized Behavior-Impacted Return of 5.25%. The behavioral impact, representing the potential value of behavioral coaching for medium-high behavioral risk investors, is quantified by the difference between the Buy-and-Hold Return and Behavior-Impacted Return, which is approximately 2.0%, in accordance with this application.

FIG. 5 illustrates an example simulated line graph representing the growth of a $1,000,000 investment in the S&P 500 from Jan. 1, 2000, to Apr. 30, 2025, for an investor classified as having medium behavioral risk (Behavioral Risk Index score of 4-6, color-coded yellow). The upper blue line reflects the Buy-and-Hold Performance, resulting in an approximate ending value of $6,000,000, corresponding to an annualized Buy-and-Hold Return of 7.28%. The lower line, rendered in yellow to match the medium BRI color code, represents the Behavior-Impacted Performance of the same investment strategy with simulated investor behavior involving market exits during periods of panic and re-entries during periods of relief, as defined for each of the four market events described herein. This behavioral pattern yields an approximate ending value of $5,000,000, corresponding to an annualized Behavior-Impacted Return of 6.50%. The behavioral impact, representing the potential value of behavioral coaching for medium behavioral risk investors, is quantified by the difference between the Buy-and-Hold Return and Behavior-Impacted Return, which is approximately 0.8%, in accordance with this application.

FIG. 6 illustrates an example simulated line graph representing the growth of a $1,000,000 investment in the S&P 500 from Jan. 1, 2000, to Apr. 30, 2025, for an investor classified as having medium behavioral risk (Behavioral Risk Index score of 0-3, color-coded green). The blue line reflecting the Buy-and-Hold Performance coincides with the Behavior-Impacted Performance line, rendered in green to match the low BRI color code, resulting in an approximate ending value of $6,000,000, corresponding to an annualized return of 7.28%. This overlap occurs because investors with low behavioral risk do not exit or re-enter during the market events described herein, due to their emotional stability. The behavioral impact, representing the potential value of behavioral coaching for low behavioral risk investors, is approximately 0%, in accordance with this application.

FIG. 7 is an example summary of the Behavioral Impact on Investment Outcomes based on Behavior Risk Index scores, where the behavioral impact is approximately 0% for investors with low behavioral risk, 0.8% for medium behavioral risk, 2% for medium-high behavioral risk, and 2.5% for high behavioral risk, in accordance with this Application.

FIG. 8 shows an example User Input Module where a financial advisor sends a link for a flow to their client Annie including three components: Risk Appetite questionnaire, Risk Tolerance Test, and Investor Type questionnaire, in accordance with this application.

FIG. 9 shows an example User Input Module when a fictional Annie clicks on the link and goes through the flow to take the behavioral assessments as part of the Behavior Risk Analyses in accordance with this application.

FIG. 10 shows an example Output Module to display the results of each behavioral factor for Annie, which will be used for Behavior Risk Analyses and Behavior Impact Simulation in accordance with this application.

FIG. 11 shows an example of Behavior Risk Visualization Module output using a donut chart, where the BRI is displayed in the middle while each segment on the donut chart represents a behavioral factor, in accordance with this application.

FIG. 12 shows an example of Behavior Impact Visualization Module output in accordance with this application.

### DETAILED DESCRIPTION OF THE INVENTION

The numerous innovative teachings of the present application will be described with particular reference to presently preferred embodiments (by way of example, and not of limitation). The present application describes several embodiments, and none of the statements below should be taken as limiting the claims generally.

For simplicity and clarity of illustration, the drawing figures illustrate the general manner of construction, and description and details of well-known features and techniques may be omitted to avoid unnecessarily obscuring the invention. Additionally, elements in the drawing figures are not necessarily drawn to scale, some areas or elements may be expanded to help improve understanding of embodiments of the invention.

The terms “first,” “second,” “third,” “fourth,” and the like in the description and the claims, if any, may be used for distinguishing between similar elements and not necessarily for describing a particular sequential or chronological order. It is to be understood that the terms so used are interchangeable. Furthermore, the terms “comprise,” “include,” “have,” and any variations thereof, are intended to cover non-exclusive inclusions, such that a process, method, article, apparatus, or composition that comprises a list of elements is not necessarily limited to those elements but may include other elements not expressly listed or inherent to such process, method, article, apparatus, or composition. A system and method is described in this invention includes specifically programmed hardware components, network system and databases, computer architectures.

All terms and terminologies in this application should be understood in the same meaning as normally used in the field of finance. In finance, the terms “cognitive bias”, “behavioral bias” or “irrational behavior” refer to investors' tendency to make investment decisions based on intuitions or gut feelings that may not be optimal from the economical perspective.

Throughout this application, the term “sequence” refers to multiple questionnaires and/or other tools that are chained together in a flow to go through in order.

In finance, the term “security” refers to an instrument that can be invested in, such as a stock, a bond, a mutual fund, or an Exchanged Traded Fund (ETF).

A “portfolio” is a group of financial securities being held by an investor with power to trade, including a combination of individual stocks, bonds, mutual funds, ETFs, and alternative investments to achieve an investment objective. Investment objectives usually mean two things: managing risk exposure and achieving financial return goals.

A “model” is a set of financial securities selected and combined in order to deliver targeted investment objectives including risks and returns that can be used as a template for investment portfolios to follow.

The term “return” in this application generally refers to the end value minus an initial value over a specified time window, i.e., the increase in value, divided by the initial value.

The term “method(s)” term means a method for object-oriented programming code whereas it performs a subroutine, normally, it comprises a sequence of programming statements to perform an action, a set of parameters to customize those actions, and possibly an output value or result.

The term “subsystem”, “engine” or “module” are used interchangeably, it represents a combination of packages and a set of executable computer codes and classes for performing a particular improved computer functions or algorithms on a computer processor or tangible memory cards. The packages contain all the elements, including unique id elements, models, source files, html files, etc. that have executable codes.

In this application, a “data module” means a set of multiple but unique methods (methodologies) for the automation of remote data network services, data communications, data analysis, data storage, data storage retrieval, data display or interactive user interfaces for data input.

A “Behavioral Analytics Engine” means a set of multiple but unique methods (methodologies) for assessing an investor's behavioral risk stemming from cognitive biases, the lack of knowledge in investments and other factors.

A “Client Analytics Engine” means a set of multiple but unique methods for assessing the client's level of satisfaction or the lack of.

The term “Behavioral Risk Index” or “BRI” refers to a numeric scoring system used in this application that summarizes the Risk Scores of various behavioral factors, including Investor Type (such as passive investor, trend follower, or contrarian), Behavior Biases (including loss aversion, overconfidence, and herding), Describe Yourself, Financial IQ, and Risk Inconsistency into one single risk index number. The BRI is expressed as a value on a scale (e.g., 0 to 10), wherein higher scores indicate greater susceptibility to emotionally driven investment decisions.

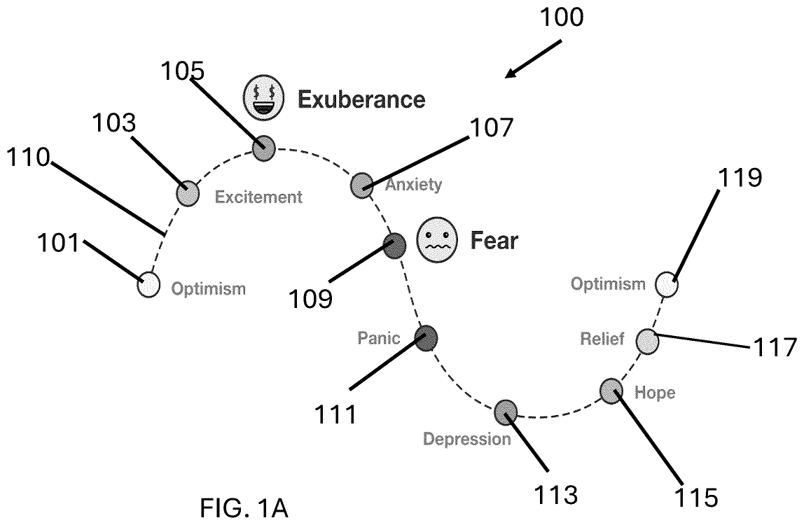

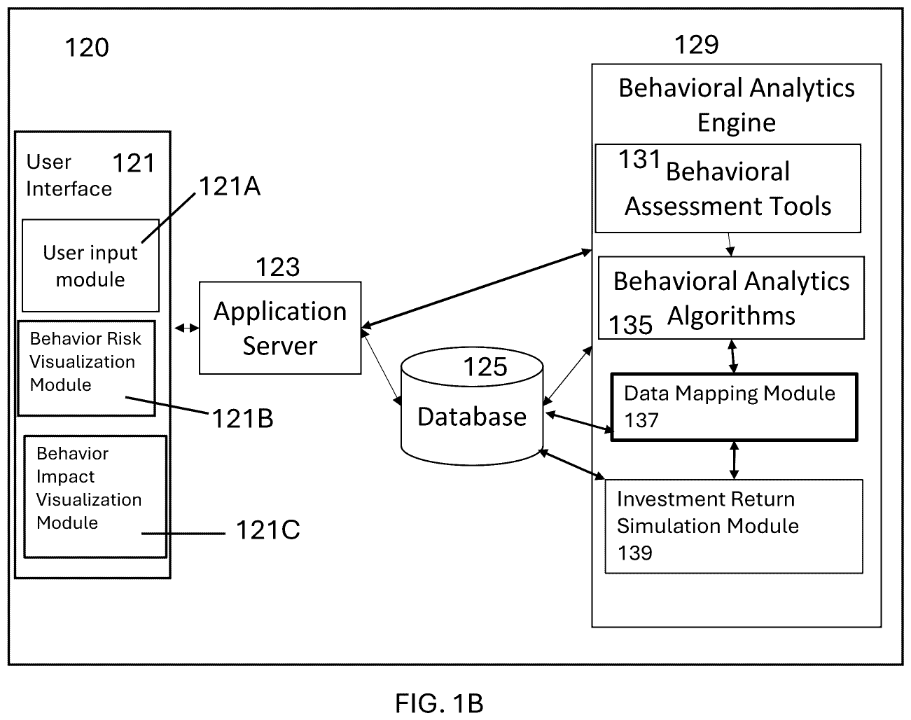

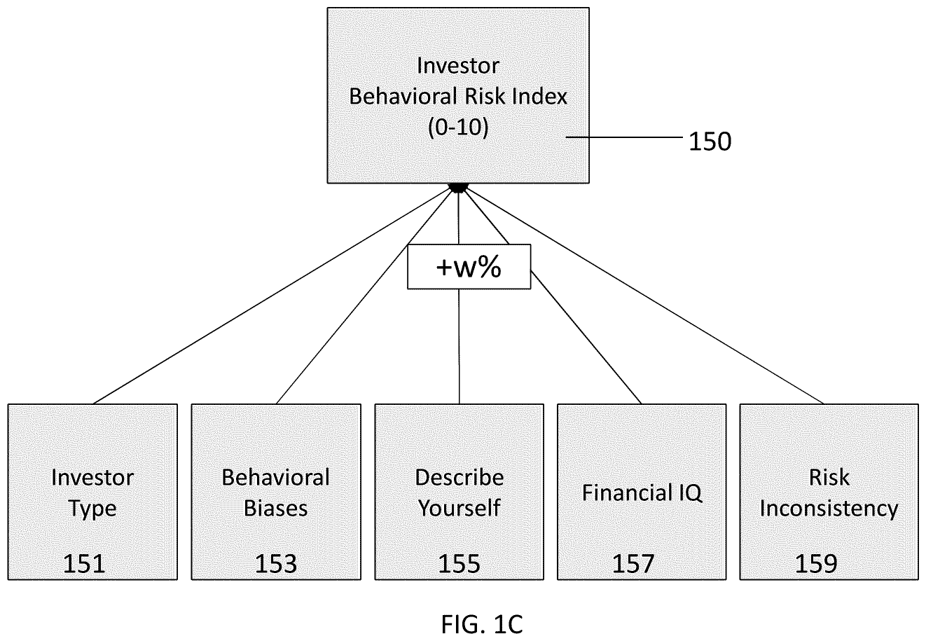

“BRI Calculation Module” means a computer module, interface and processor that calculates the BRI (0-10) based on behavioral factors such as investor type, financial IQ, and biases (e.g., loss aversion, overconfidence, herding) as shown in FIG. 1C and described in detail in the U.S. Pat. No. 11,610,266, the entirety of which is incorporated by reference.

A “graphics engine” means a set of multiple but unique methods (methodologies) for the automation of receiving analytics results and display the results on a screen or a monitor or an I/O interface according to a user's criteria.

A “server” is a functional entity that receives requests from a user or client computer and processes the requests and responds to the user or client computer in accordance with the particular requests and methods and algorithms implemented in the backend computation system.

It is contemplated and intended that the computer architecture not only functions in the client serving interface but also encapsulates application services through a service-oriented architecture layer consisting of an application layer, a business service layer, and the orchestration layer.

“Emotional Rollercoaster Model” refers to a behavioral finance framework that maps emotional states such as anxiety, fear, optimism, excitement, and euphoria to corresponding phases of the market cycle, and identifies points where investors may be prone to exit or re-enter the market based on emotional triggers rather than rational investment decisions. Investors typically progress through these emotional stages as markets fluctuate, experiencing negative emotions such as anxiety, fear, and panic during downturns, and positive emotions such as hope, relief, and exuberance during recovery. This emotional cycle, well-documented in behavioral finance literature, significantly influences investment decision-making. In some embodiments, and to help build intuition, exit and re-entry points for simulated market events may be illustratively mapped to corresponding points on the emotional rollercoaster; however, such mapping is not required or essential to the operation of the invention.

The “Investment Returns” as used in the examples are USD dollars, but the system also adopts other types of moneys or currencies, such other digital currencies and digital assets, tokenized representations of values.

As used herein, the term “Investor Behavioral Profile” refers to a data-driven representation of an investor's behavioral factors, including but not limited to investor type, behavioral biases (e.g., loss aversion, overconfidence, herding), financial literacy. A behavioral factor may or may not contribute to the Behavioral Risk Index.

As used herein, the term “Investor Persona” refers to a composite representation of an investor with a specific Investor Behavioral Profile. It may also incorporate additional attributes such as emotional tendencies, personal circumstances, preferences, and other qualitative or quantitative factors that may affect investment decision-making and portfolio management.

As used herein, the term “Buy-and-Hold Return” or “Buy-and-Hold Performance” refers to the investment return achieved by continuously holding the investment over the entire analysis period without any intermediate exits or re-entries, regardless of market conditions.

As used herein, the term “Behavior-Impacted Return” or “Behavioral-Impacted Performance” refers to the simulated or actual investment return that reflects the effect of investor behavior on portfolio performance, including, but not limited to, actions such as exiting the market during periods of perceived anxiety or uncertainty, and re-entering the market during periods of perceived excitement or optimism. The behavior-impacted return differs from a buy-and-hold return by incorporating timing deviations driven by emotional or cognitive investor responses to market events, resulting in variations in performance outcomes relative to a buy-and-hold investment strategy.

In reference to FIG. 1A, numeral 100 is an example of an overview of investor emotions during a typical market cycle, sometimes referred to as the stock market cycle but can be of any market. Numeral 110 represents the rise and fall of the market as a roller coaster. Numerals 101 to 119 represent the various emotions in responding to the market conditions in a market cycle, as represented by positions on the rollercoaster. It illustrates how the rising or dropping of the market, or the progression of significant events, elicits a range of emotional responses that influence investor behavior; hence it is also called an emotional roller coaster. The chart is contextualized by the four market events analyzed in the patent application: the 2000 Tech Bubble, 2008 Financial Crisis, COVID-19 market turmoil, and 2022 Market Correction, each of which can be visualized as a rollercoaster.

Element 110 represents the rollercoaster changes of a market or the development of an event, visualized as a curved line charting the trajectory of market conditions or event stages. The x-axis of the curve corresponds to the progression of time, while the y-axis reflects the risk and fall of a market cycle (from peak to trough to recovery) or event phases (e.g., onset, crisis, resolution), which is often correlated to the intensity of emotions or investor sentiment. The curve captures the cyclical nature of market or event developments, with peaks representing bullish markets or positive event outcomes, troughs indicating market bottoms or event crises, and recoveries showing market upswings or event resolutions. For example, in the context of the 2008 Financial Crisis, the curve would show a decline from October 2007 (start) to March 2009 (bottom) and a rise to March 2013 (recovery).

Numerals 101 to 119 represent the various emotions experienced by investors in response to the market conditions or event developments depicted by the rollercoaster curve (110). The emotions are marked along the curve, corresponding to specific points in the market cycle or event progression, and reflect the psychological states that drive investment decisions, such as exciting or re-entering the market. This application describes example emotions like optimism 101 at the beginning of an event cycle, during the upswing stage. As the market continues to rise, there is excitement 103, and at the peak stage there is that exuberance 105. Then the cycle starts to downward swings, the emotion felt is anxiety 107, and as the downward goes further, fear 109 is the feeling, further down, there is panic 111. When the cycle nears the bottom, the corresponding emotion is depression 113. Then the cycle starts to turn upwards, the emotion of hope 115 is felt, as the cycle goes further upwards, the emotion of relief 117 is expressed, and finally optimism 119 returns as the cycle swings positive again.

The emotional rollercoaster chart may come in several variations, with other behavior influence markers, such as political events of positive or negative impacts, with the one described in FIG. 1A being a typical example. As the market declines, investors typically experience a progression of emotions-anxiety, fear, panic, and depression. Conversely, as the market recovers, they move through emotions of hope, relief, optimism, excitement, and exuberance. In any case, the method and system described in this application may be employed to simulate a market performance outcome.

These positions on the emotional rollercoaster can serve as anchor points to map to market exit and re-entry points for investors with various behavioral profiles using the Behavioral Risk Index (BRI) system described in the U.S. Pat. No. 11,610,266.

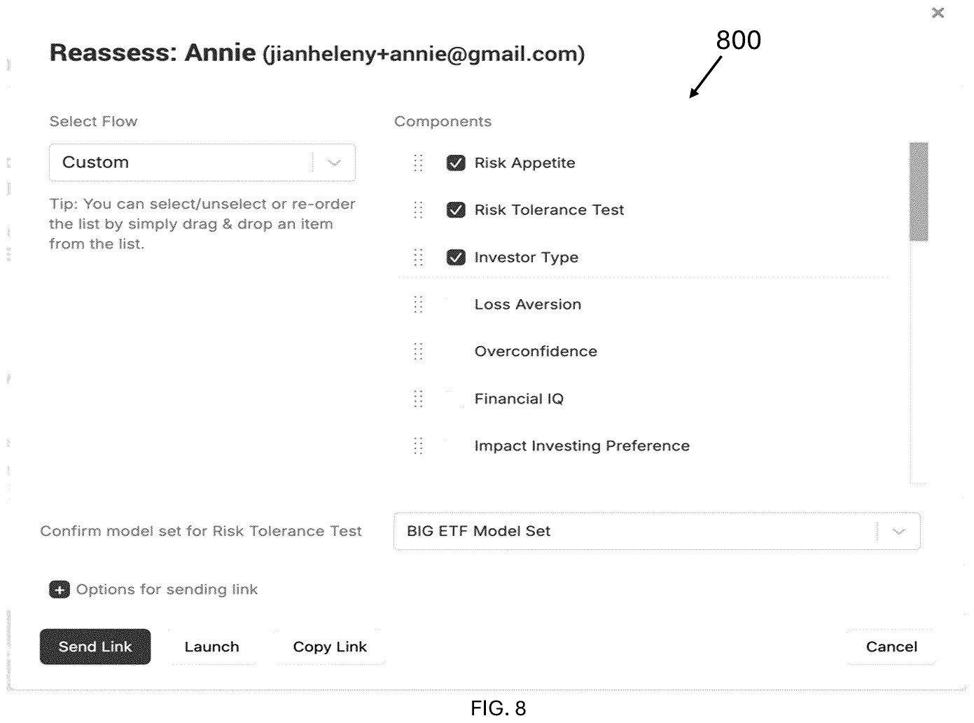

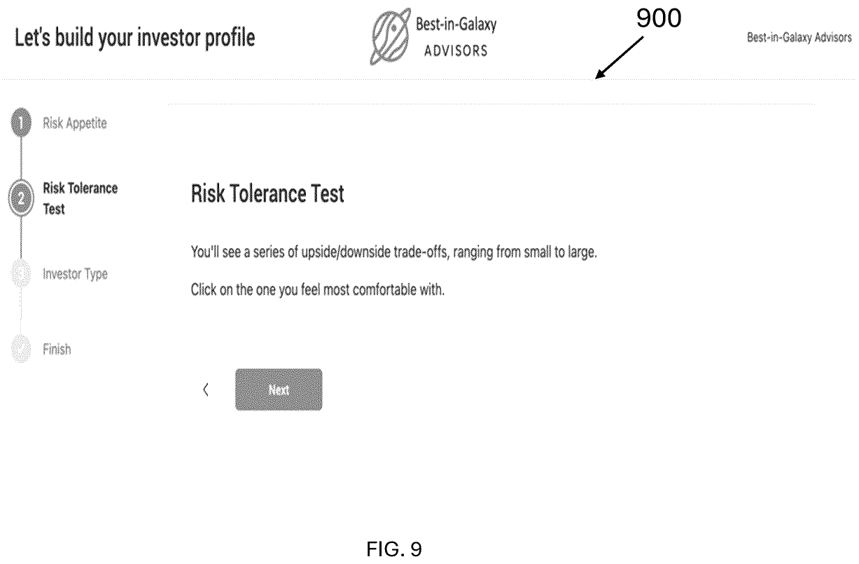

In reference to FIG. 1B, the functional components of executable instructions for Behavioral Risk Management System 120 are shown. Behavioral Risk Management System 120 includes a user interface module 121. Module 121 includes user input module 121A that receives data input and criteria from a user and sends the requests to application server 123 for processing. For user input 121A, it includes a questionnaire module, where visual or text-based questionnaires can be linked together into a flow that financial advisors can send to investors so investors can complete by themselves, or advisors can do it together with investors to assess one or more behavioral factors as shown in FIGS. 8 and 9 as a real example.

Application server 123 processes the requests received and retrieves the relevant financial data and user data from database 125 to perform the user requests. Then Behavioral Analytics Engine 129 executes behavioral assessments and calculates the behavioral risk analytics routines and stores the results in database 125. Behavioral Analytics Engine 129 includes Behavioral Assessment Questionnaires and Tools module 131 that executes behavioral assessment and collects investor's responses, while the Behavioral Analytics Algorithms module 135 processes the data and calculates behavioral analytics. Behavioral Analytics Engine 129 also includes a Data Mapping Module 137 that groups investor behavior profiles according to a shared common behavior factor, their approximate market entry and exit times and their average investment outcomes for simulation analysis in Investment Return Simulation 139. Such simulation investment results are output to be displayed in the user interface module 121.

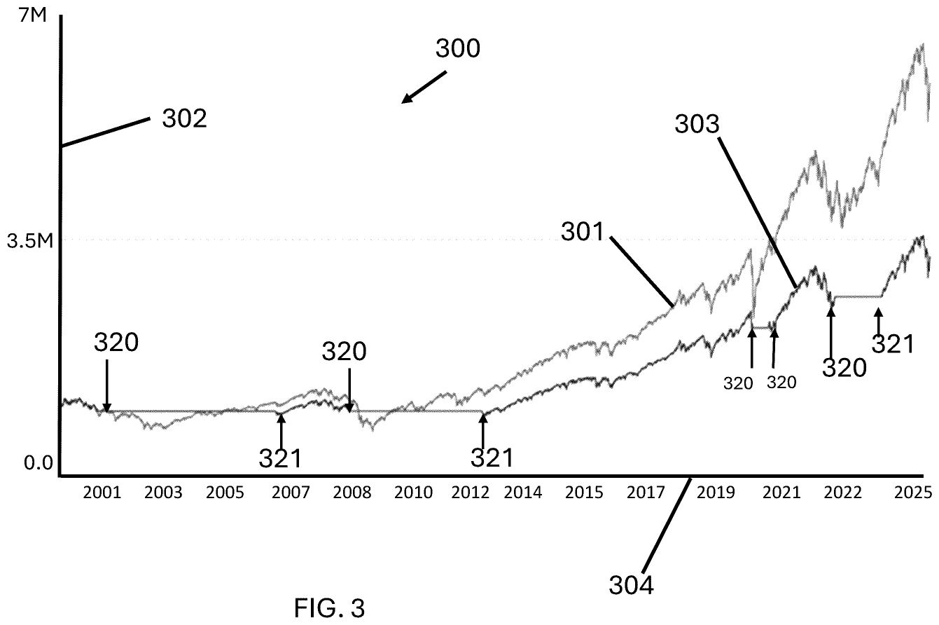

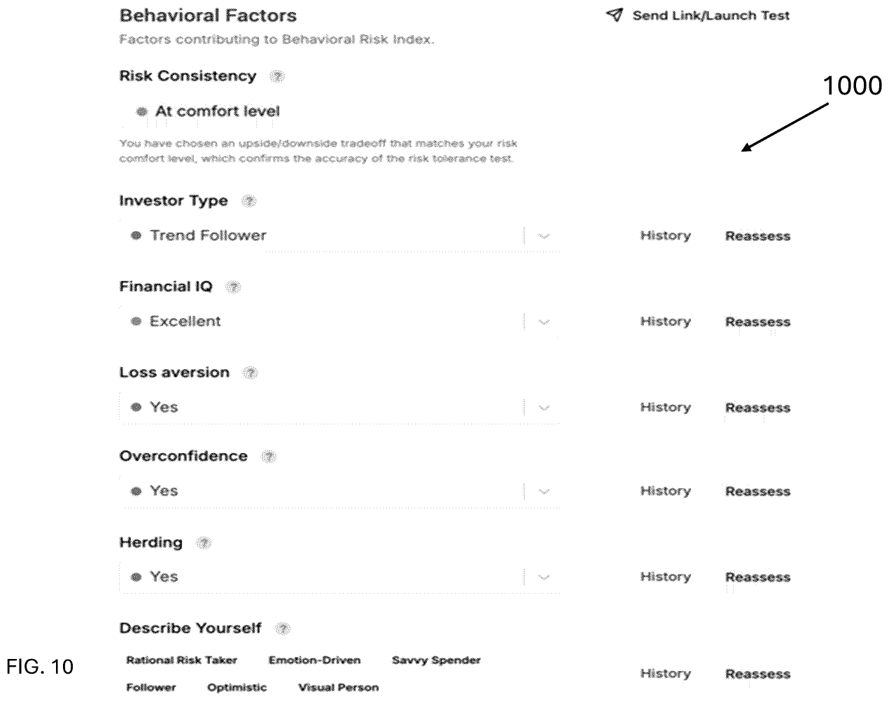

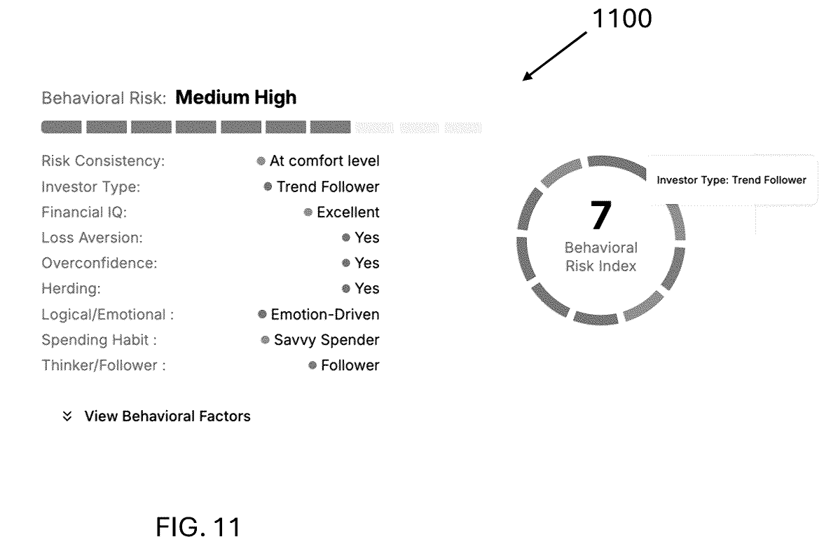

The user interface module 121 further comprises the output modules, including the Behavioral Risk Visualization Module 121B and Behavioral Impact Visualization Module 121C. For user output, it comprises the display of each behavioral factor as shown a real example in FIG. 10, these factors are modifiable manually, the Behavioral Risk Visualization Module 121B, which is further described in FIG. 1C and a real example in FIG. 11, and the Behavioral Impact Visualization Module 121C, which is further described in detail as in FIG. 3 to 7.

An investor's behaviors may be quantified using the Behavioral Risk Index (BRI) system, as described in U.S. Pat. No. 11,610,266. A single number from 0 to 10 quantifies an investor's behavioral risk. It aggregates factors such as Investor type (e.g., passive, trend-follower, contrarian), Financial IQ, Behavioral biases (e.g., loss aversion, overconfidence, herding) with adjustable weight factors determined from research data and experiences.

In the system, Data Storage Module represents the storage of historical market data, investor portfolio records, and Investor Behavioral Profile data used to validate the simulation. Process Flow Arrows connect the blocks to show the sequence of operations, from BRI calculation to performance output. Output Interface shown in FIGS. 3 to 7 may be annotated with text or voice to explain a particular investment insight.

In reference to FIG. 1C, the investor Behavioral Risk Index 150 aggregates multiple behavioral factors, using an algorithm of weighted average. The inputs include the Investor Type (151), Behavioral Biases (153) which includes multiple behavioral biases, Describe Yourself (155) which includes multiple behavioral factors, Financial IQ (157) and Risk Inconsistency (159). This is a high-level diagram.

The BRI may be represented both by a numerical number and a color-code in display for ease of interpretation, for example, 0-3 (Green) represents Low behavioral risk, in this group, investors remain calm during market turmoil, adopting a long-term perspective; 4-6 (Yellow) represents Medium behavioral risk, in this group, market fluctuations cause stress, but investors strive to avoid emotional decisions; 7-8 (Orange) represents Medium-High behavioral risk, in this group, market turmoil leads to stress and emotional decisions that may harm financial goals; 9-10 (Red) represents High Behavioral Risk, in this group, market turmoil causes significant anxiety, leading to detrimental emotional decisions.

To analyze the behavioral impact on investment strategies, investors are grouped by their Investor Persona, for example, trend followers with strong loss aversion and high financial IQ. Investor Persona can also be represented by the BRI, which may not be as granular as combinations of behavioral factors because different combinations may lead to the same BRI but is nonetheless a good model and simulation system to analyze and benchmark the impact of investor behavior on different investment strategies. When data points are limited, grouping by BRI is particularly helpful. Investor Personas are then combined with investments (for example, equity, bond or mixed), and their actions during market events to determine the typical exit and re-entry points to examine the impact of Investor Personas on investment outcomes. Exit and re-entry points are determined through empirical observations from financial advisors, self-reported actions by the investors, and, when available, transactions data.

Grouping investors by Investor Personas neutralizes the effect of personal circumstances, making it possible to analyze the effect of Investor Persona on investor actions and investment outcomes. While each individual's transactions may be affected by their life events and liquidity needs, these idiosyncratic factors cancel each other when the investors are grouped by their Investor Persona. The results are still meaningful even when the group sizes may be relatively small, for example, ranging from 20 to 50.

Generally speaking, investors with higher BRI tend to exit earlier but re-enter later. Investors with high behavioral risk tend to exit the market at the point of anxiety and remain on the sidelines until the market has recovered enough, reaching the point of excitement—before they feel confident enough to re-enter. Investors with medium-high behavioral risk exit at the point of fear, and re-enter at the point of optimism. Investors with medium behavioral risk exit at the point of panic and re-enter at the point of relief. Investors with low behavioral risk stay put, so there is no exit or re-entry. The actions taken with emotional impacts during market cycles with people characterized with various Behavioral Risk Indexes are mapped in Table 1.

TABLE 1
Data Mapping of Market Exit and Re-entry
Behaviors with Groups of Different BRIs.

| | | | | | | |
|---|---|---|---|---|---|---|
| Anxiety | Fear | Panic | Bottom | Relief | Optimism | Excitement |

| | | | | | | |
|---|---|---|---|---|---|---|
| High BRI | Exit | | | | | Re-enter |
| Medium High | | Exit | | | Re-enter | |
| BRI | | | | | | |
| Medium BRI | | | Exit | Re-enter | | |
| Low BRI (no | | | | | | |
| action) | | | | | | |

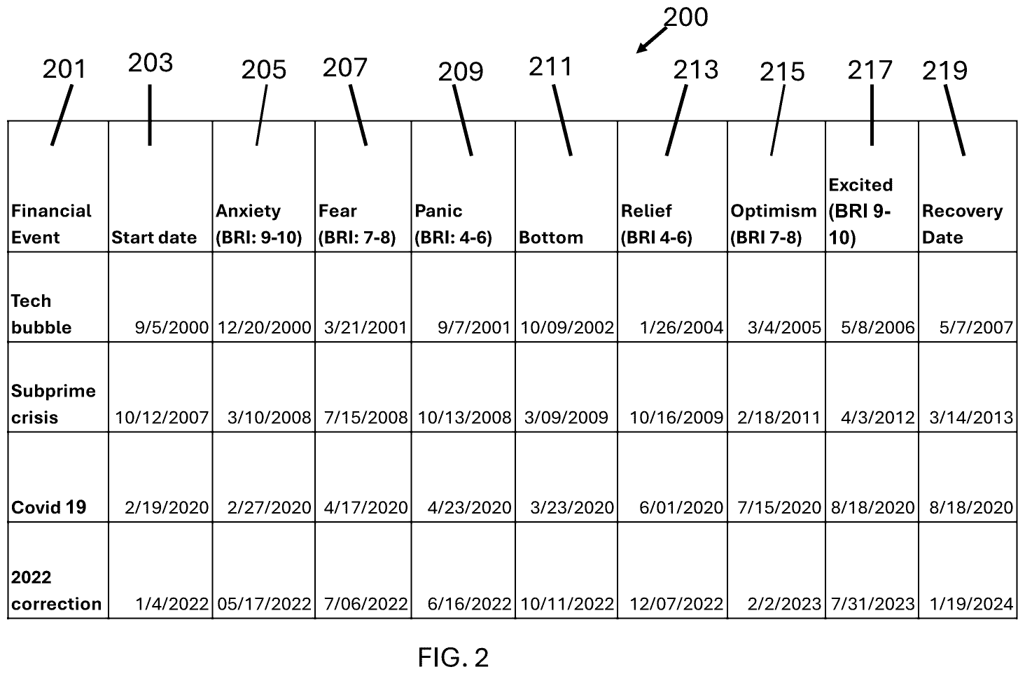

In reference to FIG. 2, a relationship between an investor's Behavioral Risk Index (BRI), the color codes being the colors used in real examples, and their exit and re-entry points during significant market events was observed. FIG. 2 presents a table shows an example of average exit and re-entry points for investors with varying BRI levels: categorized as low (0-3, color-coded green), medium (4-6, color-coded yellow), medium-high (7-8, color-coded orange), and high (9-10, color-coded red), crossing four major market events: the 2000 tech bubble, the 2008 financial crisis, the COVID-19 market turmoil, and the 2022 market correction.

FIG. 2 shows a table that maps grouped behavior according to their shared BRI score ranges. Number 201 represents the column of four different financial events, number 203 represents the start dates of the respective financial events, while number 211 represents the bottom date and number 219 the recovery date of the market for each market cycle. For each BRI category, the table indicates when investors are likely to exit the market (driven by emotions such as anxiety, fear, panic, or depression) and re-enter (driven by emotions such as relief, optimism, or excitement) based on their behavioral risk profile. Numbers 205, 207, 209 represent a general market emotion roller coaster from anxiety to fear, to panic. Number 205 also represents the typical market exit dates of the group with BRI 9-10, number 207 also represents the typical market exit dates for the group with BRI 7-8, number 209 also represents the typical market exit dates for the group with BRI 4-6. Numbers 213, 215, 217, and 219 correspond the general emotions during market recovery phase from relief to optimism to excitement, number 213 also represents market re-enter time of the group with BRI 4-6, number 215 also represents market re-enter time of the group with BRI 7-8, number 217 also represents market re-enter time of the group with BRI 9-10.

In an example computer module, the display may be coded with colors.

High BRI (Red) Investors were observed to exit early at the onset of market downturns, typically at the point of anxiety, and re-enter late, often at the point of excitement, missing significant portions of the recovery. Medium-High BRI (Orange) Investors were observed to exit at the point of fear and re-enter at the point of optimism, indicating a slightly delayed response compared to high BRI investors. Medium BRI (Yellow) Investors were observed to exit at the point of panic and re-enter at the point of relief, showing greater resilience but still succumbing to emotional pressures. Low BRI (Green) Investors were observed to typically remain invested throughout market cycles, exhibiting no exit or re-entry due to their long-term perspective and emotional stability.

The table in FIG. 2 underscores a simulation methodology based on BRIs with their impact on market timing decisions and therefore quantifies their impact on investment performance. By aligning exit and re-entry points with the emotional rollercoaster of market cycles, the simulation makes it easy to understand how higher behavioral risk correlates with suboptimal market timing, leading to reduced investment returns compared to a Buy-and-Hold return. It should be noted that the emotional rollercoaster model serves primarily as an illustrative tool to help build intuition. Investors may exit or re-enter the market at various points along the emotional rollercoaster, which may or may not coincide with predefined anchor points used in the simulation. Furthermore, while the simulation may group investors by BRI score for illustrative purposes, alternative groupings based on more granular behavioral profiles may also be employed.

In the present inventive system, such exit and re-enter market points during market cycles may be collected and statistically analyzed with each respective category of corresponding BRIs, to highlight the impact of each behavior category.

Data Mapping Module: In the example embodiment, the actions that a person may take are categorized as exiting the market and re-entering the market, based on their BRI scores: Investors exit the market during downturns due to emotions and biases (recency bias, loss aversion) are reflected in the high, medium-high, and medium BRI responses (exits at anxiety, fear, panic). This module is included in Behavior Analytics Engine 131 in FIG. 1B.

Investors re-enter the market during the recovery periods is shown in the re-entry points (excitement, optimism, relief).

While exiting during the downturn can prevent a portion of the loss, investors often exit at or near the bottom when the emotion is the strongest. Furthermore, investors often re-enter too late and miss a good portion of the recovery. The impact of market timing, such as exiting too late, re-entering too late, missing recovery gains, etc. is simulated in this patent application, showing how higher BRI investors underperform low BRI investors who stay invested.

Exit and Re-Entry Points are identified with empirical observations of financial advisors when working with clients, as well as data points directly from investors. Investors may be grouped by certain separate behavioral factors, for example, trend followers with strong loss aversion and moderate financial IQ, for a more detailed analysis of their behavior influenced exit and re-entry points.

The results show that investors with higher behavioral risk are more likely to exit the market earlier than those with lower behavioral risk, as their emotional triggers are activated at lower thresholds. Similarly, they tend to re-enter the market later, needing more reassurance to overcome the emotional barrier to getting back in.

Further Simulation Module of Financial Returns: an example computer module of showing the simulated results of investor behaviors during market cycles, is developed, using the empirically observed exit and re-entry points of groups with different BRIs.

Performance Quantification Module conducts simulated market returns in the comparison of simulated returns to a buy-and-hold strategy, quantifying the impact of BRI-driven behavior, the system analyzes the following market events, using the SP 500 as a proxy with historical market data and investor trading records.

Historical market data is used to calculate the daily returns of each market period. The market price of an investment portfolio of each day is used to calculate daily total return for that period according to industry standard.

FIG. 3 illustrates the simulated performance impact for high Behavioral Risk Index (BRI) investors (BRI score of 9-10, color-coded red). FIG. 3 (300) is a line graph depicting the growth of a $1,000,000 investment in the S&P 500 from Jan. 1, 2000, to Apr. 30, 2025, for an investor with high behavioral risk. The blue line (301) represents the Buy-and-Hold Performance, reaching approximately $6,000,000 by Apr. 30, 2025, corresponding to an annualized Buy-and-Hold Return of 7.28%. The lower line (303), rendered as red to match the high BRI color code, illustrates the Behavior-Impacted Performance of the same investment strategy with simulated investor behavior involving market exits during periods of anxiety and re-entries during periods of excitement, as defined for each of the four market events described therein. This behavioral pattern yields an approximate end value of $3,200,000, corresponding to an annualized Behavior-Impacted Return of 4.74%. The x-axis (304) spans the period from Jan. 1, 2000, to Apr. 30, 2025, with annotated market event dates. The y-axis (302) ranges from $1,000,000 to $7,000,000. Each pair of markers (320, 321) identifies the exit and re-entry points corresponding to individual market cycles. The flat segments between each pair of markers (320, 321) indicate periods during which the investor remains out of the market, thereby realizing no gains or losses during those intervals. As shown in FIG. 3, after each exit and re-entry, the investor experiences a cumulative performance loss due to missed recoveries. The behavioral impact, representing the potential value of behavioral coaching for high behavioral risk investors, is quantified by the difference between the Buy-and-Hold Return and Behavior-Impacted Return, which is approximately 2.5%.

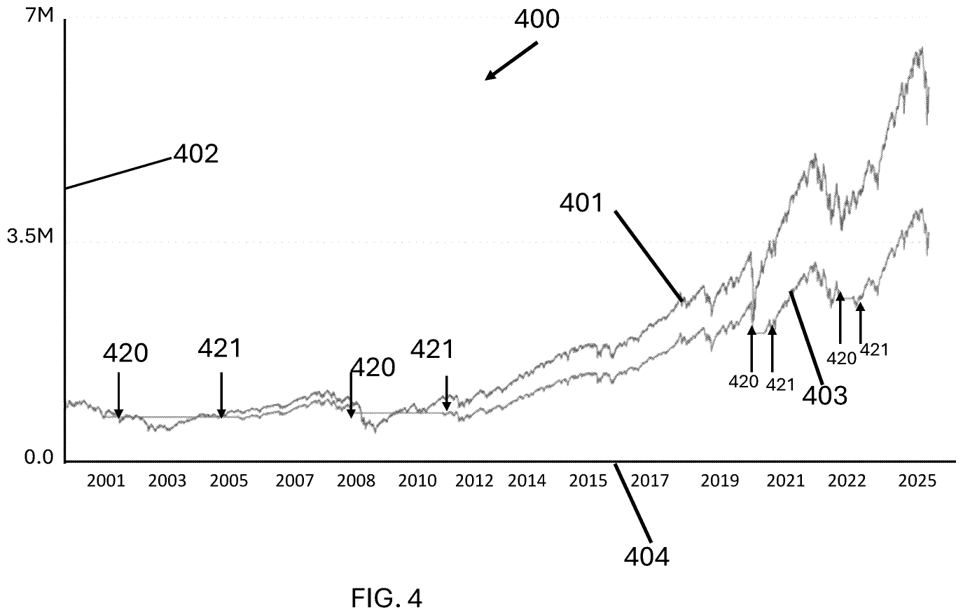

FIG. 4 illustrates the simulated performance impact for medium-high BRI investors (BRI score of 7-8, color-coded orange). FIG. 4 (400) is a line graph depicting the growth of a $1,000,000 investment in the S&P 500 from Jan. 1, 2000, to Apr. 30, 2025, for an investor with medium-high behavioral risk. The blue line (401) represents the Buy-and-Hold Performance, reaching approximately $6,000,000 by Apr. 30, 2025, corresponding to an annualized return of 7.28%. The lower line (403), rendered as orange to match the medium-high BRI color code, illustrates the Behavior-Impacted Performance of the same investment strategy with simulated investor behavior involving market exits during periods of fear and re-entries during periods of optimism, as defined for each of the four market events described therein. This behavioral pattern yields an approximate end value of $3,700,000, corresponding to an annualized Behavior-Impacted Return of 5.25%. The x-axis (404) spans the period from Jan. 1, 2000, to Apr. 30, 2025, with annotated market event dates. The y-axis (402) ranges from $1,000,000 to $7,000,000. Each pair of markers (420, 421) identifies the exit and re-entry points corresponding to individual market cycles. The flat segments between each pair of markers (420, 421) indicate periods during which the investor remains out of the market, thereby realizing no gains or losses during those intervals. As shown in FIG. 4, after each exit and re-entry, the investor experiences a cumulative performance loss due to missed recoveries. The behavioral impact, representing the potential value of behavioral coaching for medium-high behavioral risk investors, is quantified by the difference between the Buy-and-Hold Return and Behavior-Impacted Return, which is approximately 2.0%.

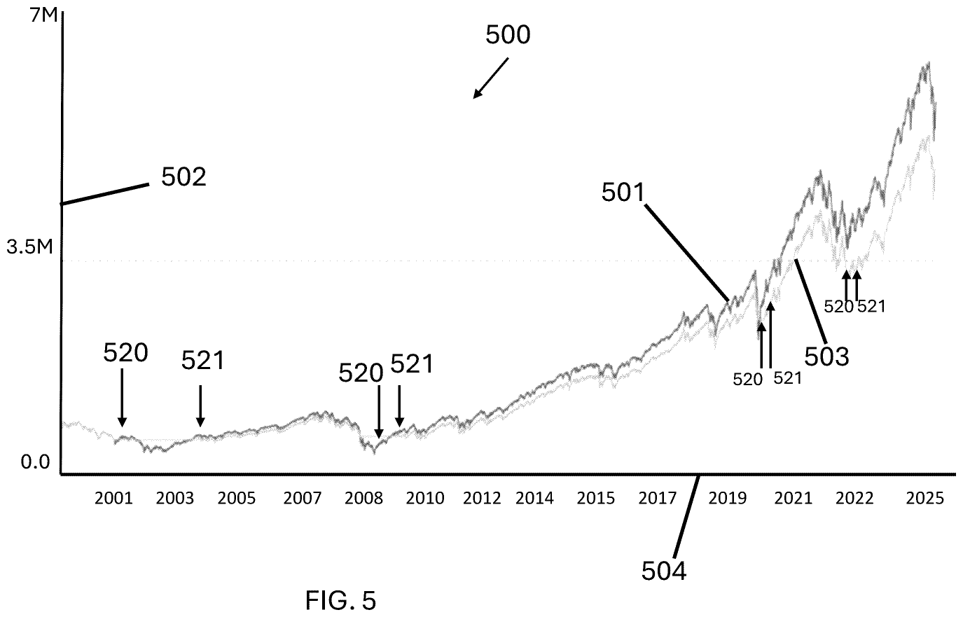

FIG. 5 illustrates the simulated performance impact for medium BRI investors (BRI score of 4-6, color-coded yellow). FIG. 5 (500) is a line graph depicting the growth of a $1,000,000 investment in S&P 500 from Jan. 1, 2000, to Apr. 30, 2025, for an investor with medium behavioral risk. The blue line (501) represents the Buy-and-Hold Performance, reaching approximately $6,000,000 by Apr. 30, 2025, corresponding to an annualized Buy-and-Hold Return of 7.28%. The lower line (503), rendered as yellow to match the medium BRI color code, illustrates the Behavior-Impacted Performance of the same investment strategy with simulated investor behavior involving market exits during periods of panic and re-entries during periods of relief, as defined for each of the four market events described therein. This behavioral pattern yields an approximate end value of $5,000,000, corresponding to an annualized Behavior-Impacted Return of 6.50%. The x-axis (504) spans the period from Jan. 1, 2000, to Apr. 30, 2025, with annotated market event dates. The y-axis (502) ranges from $1,000,000 to $7,000,000. Each pair of markers (520, 521) identifies the exit and re-entry points corresponding to individual market cycles. The flat segments between each pair of markers (520, 521) indicate periods during which the investor remains out of the market, thereby realizing no gains or losses during those intervals. As shown in FIG. 5, after each exit and re-entry, the investor experiences a cumulative performance loss due to missed recoveries. The behavioral impact, representing the potential value of behavioral coaching for medium behavioral risk investors, is quantified by the difference between the Buy-and-Hold Return and Behavior-Impacted Return, which is approximately 0.8%.

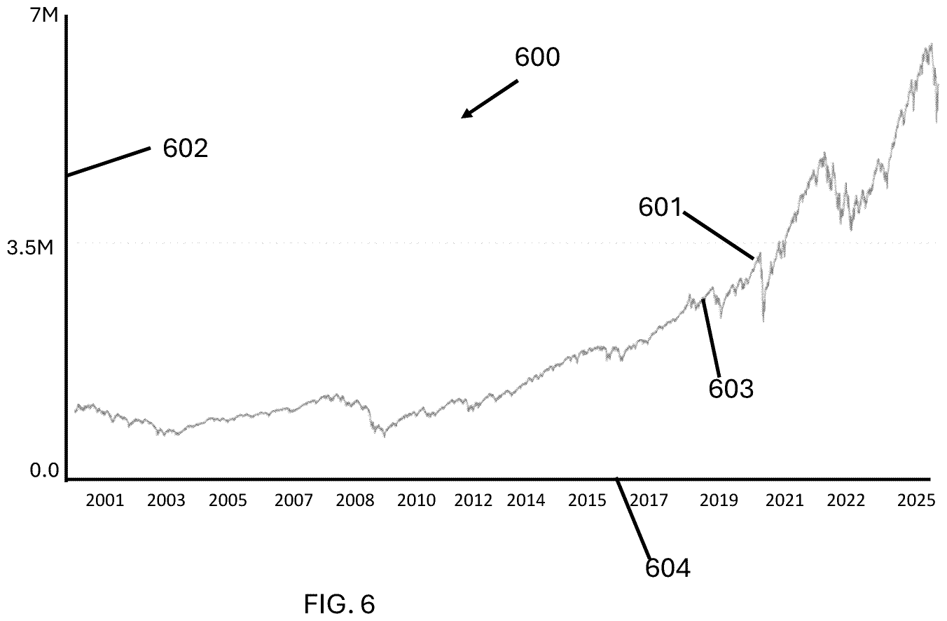

FIG. 6 illustrates a simulated line graph representing the growth of a $1,000,000 investment in the S&P 500 from Jan. 1, 2000, to Apr. 30, 2025, for an investor classified as having low behavioral risk (Behavioral Risk Index score of 0-3, color-coded green). The blue line (601) reflecting the Buy-and-Hold Performance coincides with the Behavioral-Impacted Performance line (603), which is rendered in green to match the low BRI color code, resulting in an approximate ending value of $6,000,000, corresponding to an annualized return of 7.28%. This overlap occurs because investors with low behavioral risk do not exit or re-enter during the market events described herein, due to their emotional stability. The behavioral impact is approximately 0%. The x-axis (604) spans the period from Jan. 1, 2000, to Apr. 30, 2025, with annotated market event dates. The y-axis (602) ranges from $1,000,000 to $7,000,000.

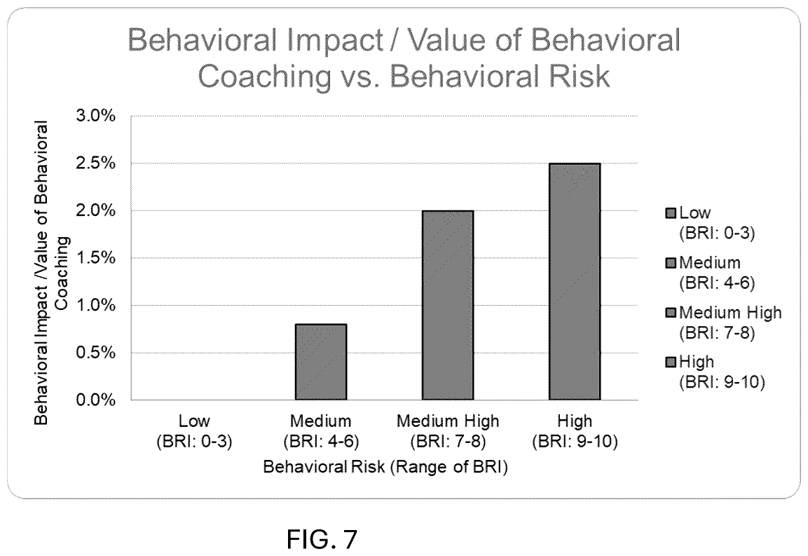

FIG. 7 is an example summary in the form of bar charts of the Behavioral Impact on Investment Outcomes in terms of annual returns based on Behavior Risk Index scores, where the behavioral impact is approximately 0% for investors with low behavioral risk, 0.8% for medium behavioral risk, 2% for medium-high behavioral risk, and 2.5% for high behavioral risk, for a 100% stock portfolio. This indicates that the higher the behavioral risk, the higher the negative impact of investor behavior on investment outcomes, hence the higher value of behavioral coaching of financial advisors. Note that the numbers will vary for different asset allocations. For example, the behavioral impact on a typical 60/40 portfolio consisting of 60% stocks and 40% bonds is likely smaller compared to a 100% stock portfolio.

FIGS. 8 to 9 are real prototype developments that show the User Input Module, as in 121A in FIG. 1B. For example, FIG. 8 module 800 shows a financial advisor sending a link of a flow to their client Annie, and the flow includes three components: Risk Appetite questionnaire, Risk Tolerance Test, and Investor Type questionnaire. When Annie receives the link in her email, she clicks on the link and goes through the flow to assess each of the three behavioral factors, which is shown in FIG. 9. The progress bar on the left indicates where the investor's progression in completing the flow. Her inputs were analyzed by the Behavior Analytics Engine and her behavior profile results are displayed in FIG. 10 to 12.

FIGS. 10 to 12 are real prototype developments that show the Output Module including Behavioral Risk Visualization Module and Behavioral Impact Visualization Module as in 121B and 121C in FIG. 1B.

FIG. 10 shows an example adjustable User Input Output Module to display the results of each behavioral factor for Annie, which will be used for Behavior Risk Analyses and Behavior Impact Simulation in accordance with this application. For example, it shows that Annie's Investor Type is a Trend Follower.

FIG. 11 shows an example of Behavior Risk Visualization Module output using a donut chart, where the BRI is displayed in the middle while each segment on the donut chart represents a behavioral factor. This is an alternative visualization of FIG. 10, when the same behavioral factors are displayed on the donut chart and the legend on the left.

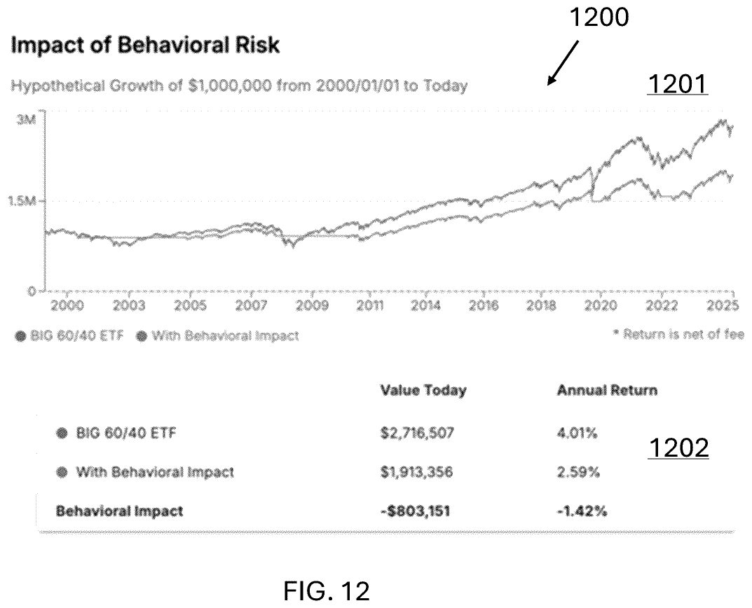

Her behavior impact can be further analyzed using the Data Mapping Module, as grouped by her BRI, and simulated through the Investment Simulation Module using general market data, the simulated investment results over a selected period time are displayed in FIG. 12, both as a line graph over time as shown in panel 1201 and/or as annual impact in text, or voice message or insight shown in panel 1202. Annie or her financial advisor can also update her behavior factors as needed in FIG. 10, and her BRI and the donut chart will be updated accordingly in FIG. 11, as well as the behavioral impact on FIG. 12. Annie may play with those behavior factors by manually changing them to view a visualization of their impacts of those behavior factors on her investment returns for a particular period of time. The Simulation Module also allows the user to select a particular interested time frame in selecting those periods of market data.

The simulation engine provides visual effects for individual investors to understand the impact of investor behavior and to improve strategies, it quantifies behavioral impacts to help investors make better-informed choices. It provides a framework and guidance for financial advisors to give tailored advice based on BRI profiles. It offers Institutional Investors an enhanced risk management tool for product development. In addition, it provides deeper market understanding by integrating sentiment investment analysis.

As will be recognized by those skilled in the art, the innovative concepts described in the present application can be modified and varied over a tremendous range of applications, and accordingly the scope of patented subject matter is not limited by any of the specific exemplary teachings given. It is intended to embrace all such alternatives, modifications and variations that fall within the spirit and broad scope of the appended claims. None of the description in the present application should be read as implying that any particular element, step, or function is an essential element which must be included in the claim scope: THE SCOPE OF PATENTED SUBJECT MATTER IS DEFINED ONLY BY THE ALLOWED CLAIMS. Moreover, none of these claims are intended to invoke paragraph six of 35 USC section 112 unless the exact words “means for” are followed by a participle. The claims as filed are intended to be as comprehensive as possible, and NO subject matter is intentionally relinquished, dedicated, or abandoned.

1. A computing system for quantifying an impact of an investor's behavioral profile factor on investment outcomes, comprising:
a computer database configured to store historical market data, an investor Portfolio, and an Investor Behavioral Profile including representing one or more Investor Persona;
a computer User Interface module configured to receive user input data and criteria associated with the Investor Behavioral Profile;
a Behavioral Risk Visualization Module being part of the user interface module configured to display an output of Investor Behavioral Profile including the visual display of a Behavioral Risk Index;
a Behavioral Impact Visualization Module being part of the user interface module configured to display an output of quantified Behavioral Impact on an investment strategy;
a Behavioral Analytics Engine comprising:
a Behavioral Assessment Tools module configured to collect responses from the investor to assess a behavioral factor, including investor type, financial IQ, and a behavioral bias;
a Behavioral Analytics Algorithms module configured to calculate a Behavioral Risk Index (BRI) score, wherein the BRI score quantifies the investor's behavioral risk;
a Data Mapping Module configured to collect and map a particular action for the investor, wherein a relationship between the particular action and an Investor Persona, identified by the BRI score or the Investor Behavioral Profile, is statically analyzed among a sample group having the same Investor Persona;
an Investment Return Simulation Module configured to calculate and compare a Buy-and-Hold Investment Return of an investment strategy, with a simulated or an actual Behavior-Impacted Return incorporating the particular action, to quantify an behavioral impact by the particular action on investment outcomes and thereby to demonstrate the potential value of behavioral coaching provided by financial professionals; and
an application server communicatively coupled to the database, the user interface module, the Behavioral Analytics Engine, the Data Mapping Module, and the Investment Return Simulation Module, configured to process requests and deliver a personalized investment performance insight on a display.

2. The system of claim 1, wherein a donut chart having a plurality of segments in the Behavioral Risk Visualization Module is configured to display an investor's behavioral risk, including the Behavioral Risk Index, with each segment of the donut chart representing a behavioral factor contributing to the Behavioral Risk Index.

3. The system of claim 1, wherein the BRI score is color-coded as follows:
a. 0-3, with a color representing low behavioral risk;
b. 4-6, with a color representing medium behavioral risk;
c. 7-8, with a color representing medium-high behavioral risk; and
d. 9-10, with a color representing high behavioral risk.

4. The system of claim 1, wherein the particular action is an action of exiting or re-entering into an investment market at a particular market cycle.

5. The system of claim 1, wherein the Data Mapping Module is further configured to group investors by an Investor Persona and an investment strategy, including equity, bond, or a combination of investor portfolios, to determine a correlation or sub-correlation relationship between the particular action and the Investor Persona.

6. The system of claim 4, wherein the Behavioral Impact Visualization module is a graphics engine configured to display the Buy-and-Hold Return and the Behavior Impacted Return as a line graph or a bar chart.

7. A computer-implemented method for quantifying an impact of investor behavioral risk on investment outcomes, comprising:
receiving, via a User Interface module, input data and criteria related to an Investor Behavioral Profile representing one or more Investor Persona;
collecting, via a Behavioral Assessment Tools module, responses from the investor to assess behavioral factors, including investor type, financial IQ, and behavioral biases;
calculating, via a Behavioral Analytics Algorithms module, a Behavioral Risk Index (BRI) score based on the behavioral factors, wherein the BRI score quantifies the investor's behavioral risk;
collecting and mapping, via a Data Mapping Module, a particular action for an investor, wherein a relationship between the particular action and an Investor Persona is statically analyzed among a sample group having the same Investor Persona;
calculating and simulating, via an Investment Return Simulation Module, an investment outcome by comparing a Buy-and-Hold Return of an investment strategy, based on historical market data, with a simulated or actual Behavior-Impacted Return incorporating the particular action, to quantify a behavioral impact on investment outcomes, thereby demonstrating a potential value of behavioral coaching; and
displaying, via a Behavioral Risk Visualization Module, an output of the Investor Behavioral Profile including the Behavioral Risk Index and behavioral factors and an Investor Persona; and
displaying, via a Behavioral Impact Visualization Module, an output of a Behavioral Impacted Return of the particular action on investment strategies.

8. The method of claim 7, wherein a donut chart having a plurality of segments in the Behavioral Risk Visualization Module is configured to display a investor's behavioral risk, including the Behavioral Risk Index, with each segment of the donut chart representing a behavioral factor contributing to the Behavioral Risk Index.

9. The method of claim 7, wherein the particular action is an action of exiting or re-entering a market in a particular market cycle.

10. The method of claim 7, wherein
for a BRI score of 9-10, an exit action is mapped to an anxiety emotional state and a re-entry action is mapped at an excitement emotional state of a market cycle;
for a BRI score of 7-8, an exit action is mapped at a fear emotional state and a re-entry action is mapped at an optimism emotional state of market cycle;
for a BRI score of 4-6, an exit action is mapped at a panic emotional state and a re-entry action is mapped at a relief emotional state of market cycle; and
for a BRI score of 0-3, no action of exiting or re-entry is mapped in a market cycle.

11. The method of claim 7, wherein a set of predefined market cycles is provided for simulation comparison including at least one of the 2000 Tech Bubble, the 2008 Financial Crisis, the COVID-19 market turmoil, and the 2022 Market Correction.

12. The method of claim 7, further comprising grouping investors by Investor Persona and investment strategy, including equity, bond, or mixed portfolios, to determine a correlation or sub-correlation relationship between the particular action and Investor Persona.

13. The method of claim 7, further comprising displaying, via a Behavioral Impact Visualization Module, a Buy-and-Hold Performance and a Behavior-Impacted Performance as a line graph or a bar chart.

14. A non-transitory computer-readable medium storing instructions that, when executed by a processor, cause the processor to perform a method for quantifying the impact of investor behavioral risk on investment outcomes, the method comprising:
receiving input data and criteria related to an investor's behavioral profile;
collecting responses from the investor to assess behavioral factors, including investor type, financial IQ, and behavioral biases;
calculating a Behavioral Risk Index (BRI) score ranging from 0 to 10 based on the behavioral factors, wherein the BRI score quantifies the investor's behavioral risk;
collecting and mapping a particular action for an investor, wherein a relationship between the particular action and the Investor Persona is statically analyzed among a sample group having a same Investor Persona;
calculating and simulating, via an Investment Return Simulation Module, an investment outcome for the investor by comparing a Buy-and-Hold Return of an investment strategy, based on historical market data, with a simulated or actual Behavior-Impacted Return incorporating the particular actions, to quantify the behavioral impact on investment outcomes and thereby demonstrate a potential value of behavioral coaching provided by financial professionals; and
outputting, via a Behavioral Risk Visualization Module, an Investor Behavioral Profile including a Behavioral Risk Index; and
outputting personalized an investment behavioral insight based on the simulated investment outcomes.

15. The non-transitory computer-readable medium of claim 14, wherein a donut chart having a plurality of segments in the Behavioral Risk Visualization Module is configured to display an investor's behavioral risk, including a Behavioral Risk Index, with each segment of the donut chart representing a behavioral factor contributing to the Behavioral Risk Index.

16. The non-transitory computer-readable medium of claim 14, wherein the particular action is an action of exiting or reentering a market during a market cycle.

17. The non-transitory computer-readable medium of claim 16, wherein mapping the action of exiting and re-entering comprises:
for a BRI score of 9-10, the action of exiting is mapped at an anxiety emotional state and the action of re-entering is mapped at an excitement emotional state during a market cycle;
for a BRI score of 7-8, the action of exiting is mapped at a fear emotional state and the action of re-entering is mapped at an optimism emotional state during a market cycle;
for a BRI score of 4-6, the action of exiting is mapped at a panic emotional state and the action of re-entering is mapped at a relief emotional state; and
for a BRI score of 0-3, no action of exiting or the action of re-entering is mapped.

18. The non-transitory computer-readable medium of claim 14, wherein a set of predefined market cycles is provided including at least one of the 2000 Tech Bubble, the 2008 Financial Crisis, the COVID-19 market turmoil, and the 2022 Market Correction.

19. The non-transitory computer-readable medium of claim 14, wherein the method further comprises grouping investors by an Investor Persona and an investment strategy, including equity, bond, or mixed portfolios, to determine a correlation or sub-correlation relationship between the particular action and the Investor Persona.

20. The non-transitory computer-readable medium of claim 14, wherein the method further comprising displaying, via a Behavioral Impact Visualization Module, a Buy-and-Hold Performance and a Behavior-Impacted Performance as a line graph or a bar chart.
